(19) United States
(12) Patent Application Publication
(10) Pub. No.: US 2016/0279802 A1
(43) Pub. Date: Sep. 29, 2016

(54) SYSTEM FOR OPERATING A ROBOTIC ASSEMBLY

(71) Applicant: Caterpillar Inc., Peoria, IL (US)

(72) Inventors: Craig Kietzman, Bloomington, IL (US); David Merle Miller, Peoria, IL (US)

(73) Assignee: Caterpillar Inc., Peoria, IL (US)

(21) Appl. No.: 15/176,320

(22) Filed: Jun. 8, 2016

(51) Int. Cl. B25J 13/00; B25J 9/16

(52) U.S. Cl. CPC B25J 13/006; B25J 9/1689; B25J 11/0075

(57) ABSTRACT

A system for wirelessly operating an end effector and a robotic arm of a robotic assembly includes a remote control having a sensor for generating movement data corresponding to a movement of the remote control by a user, and a primary switch operable to commence a logging of spatially defined points present in the generated movement data. The system also includes a receiver in wireless communication with the remote control, a processor communicably coupled to the receiver, and a controller communicably coupled to the processor, the memory, and an actuator associated with the robotic assembly. The receiver receives the movement data from the sensor. The processor logs the spatially defined points in a memory in response to the primary switch being actuated. The controller commands the actuator for initiating movement of at least one of the robotic arm and the end effector based on the logged spatially defined points.

### TECHNICAL FIELD

The present disclosure relates to a system for operating an automated machine. More particularly, the present disclosure relates to a system for wirelessly operating a robotic arm and an end effector of an automated machine.

### BACKGROUND

Many labor-intensive processes such as welding, grinding, deburring, torch cutting, painting, and material handling often require a significant investment in manual labor. It is well known in the art to automate various operations for increasing efficiency in a work environment using specifically designed machines such as robotic assemblies. A robotic assembly typically includes an articulated robotic arm having an end effector such as a gripper, or other specialized work tools including, but not limited to, welding electrodes, welding torches, paint sprayers and the like.

In many cases, the robotic assemblies would be required to repetitively perform certain functions that are consistent with pre-determined part dimensions. Various control systems and methods have been developed to actuate movement of the articulated arm associated with the robotic assembly. U.S. Pat. No. 8,972,057 discloses a method of automatic path planning for at least one robot within a confined configuration space. The robot includes an arm having a plurality of joints and an end effector coupled to the arm. The method includes entering a plurality of process points into a computer, each process point being a location in which the arm is to be positioned to perform a task. The method further includes calculating one or more inverse kinematic solutions for each process point, clustering the inverse kinematic solutions into a set of clusters, and generating collision free paths between the clusters in the confined configuration space.

However, in some cases, it may be desirous to configure the robotic assembly depending on a type of operation to be performed, a size of component to be worked on, or other specific requirements associated with a given application. Such variations may potentially present operational challenges associated with use of fixed automation solutions.

Hence, there is a need for a system that overcomes the aforementioned shortcomings by providing flexibility and ease in configuring a robotic assembly should the robotic assembly be required to perform operations to suit the varying nature of the process controls.

### SUMMARY OF THE DISCLOSURE

In an aspect of present disclosure, a system for wirelessly operating an end effector and a robotic arm associated with a robotic assembly includes a remote control. The remote control includes a sensor that generates movement data corresponding to a movement of the remote control by a user, and a primary switch operable to commence a logging of spatially defined points present in the generated movement data. The system also includes a receiver disposed in wireless communication with the remote control, a processor communicably coupled to the receiver, and a controller that is communicably coupled to the processor, the memory, and at least one actuator associated with the robotic assembly. The receiver receives the movement data generated by the sensor. The processor logs the spatially defined points in a memory in response to the primary switch being actuated. The controller commands the actuator for initiating movement of at least one of the robotic arm and the end effector based on the logged spatially defined points.

Other features and aspects of this disclosure will be apparent from the following description and the accompanying drawings.

### BRIEF DESCRIPTION OF THE DRAWINGS

FIG. 1 is a schematic view of a system for operating a robotic arm and an end effector of an exemplary robotic assembly, in accordance with an embodiment of the present disclosure;

FIG. 2 is an exemplary pictorial representation of movement data and logged spatially defined points in the movement data, in accordance with an embodiment of the present disclosure;

FIG. 3 is a schematic of a low-level implementation of a computer-based system that can be configured to perform functions associated with a processor of the system from FIG. 1, in accordance with an embodiment of the present disclosure; and

FIG. 4 is a flowchart illustrating a method of operating the robotic arm and the end effector of the exemplary robotic assembly, in accordance with an embodiment of the present disclosure.

### DETAILED DESCRIPTION

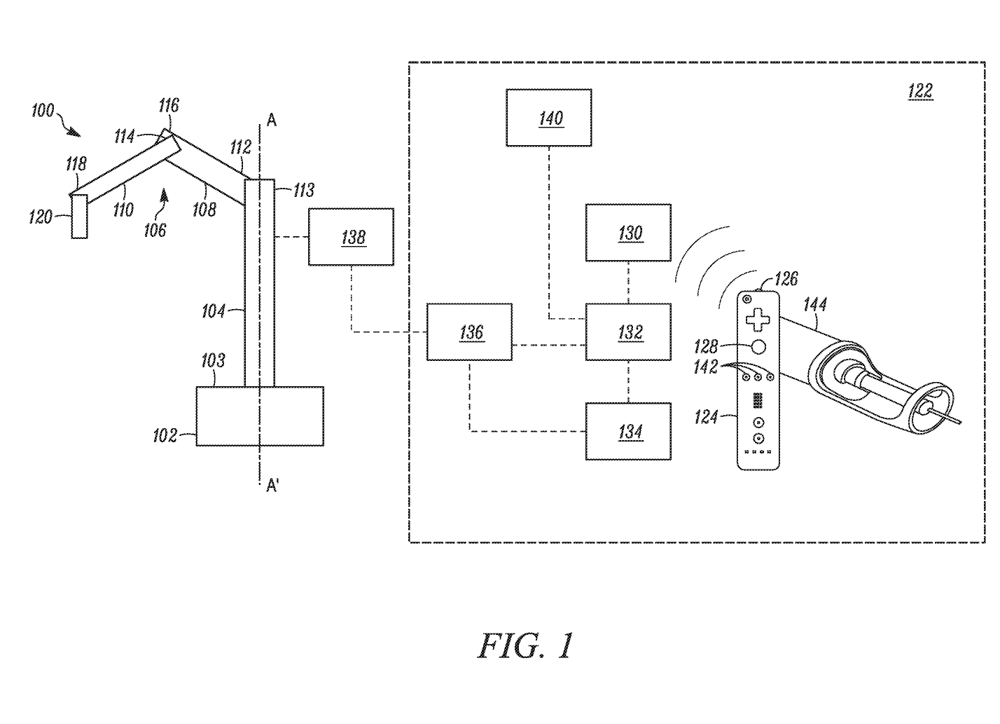

FIG. 1 illustrates an exemplary robotic assembly 100 being controlled by a system 122 of the present disclosure, in accordance with embodiments of the present disclosure. As shown, the robotic assembly 100 includes a base 102, which in one embodiment could be fixed in position. Alternatively, the base 102 could be embodied as a mobile base that is capable of moving on a surface not shown). The base 102 bears a support mast 104 thereon which may be configured to operatively swivel about an axis AA' normal to a surface 103 of the base 102.

It may be noted that the robotic assembly 100 depicted in FIG. 1 is one of the many configurations of robotic assemblies known in the art. Numerous configurations of robotic assemblies can be contemplated by persons having skill in the art and it will be appreciated that systems and methods disclosed herein can be equally applied to any type of robotic assembly regardless of its configuration.

The exemplary robotic assembly 100 includes a robotic arm 106. As shown in the illustrated embodiment of FIG. 1, the robotic arm 106 includes a pair of linkages i.e., a first linkage 108 and a second linkage 110. A first end 112 of the first linkage 108 is pivotally coupled to an upper end 113 of the support mast 104, while a first end 114 of the second linkage 110 is pivotally coupled to a second end 116 of the first linkage 108. Although only two linkages are shown pivotally coupled in this configuration, in other embodiments, the robotic arm 106 may include fewer or more linkages to suit specific requirements of an application.

Further, a second end 118 of the second linkage 110 pivotally supports an end effector 120. The end effector 120 disclosed herein may include any type of work tool including, but not limited to, a welding electrode, a welding torch, a gripper, a paint spray gun, a cutter, a grinding wheel, or any other type of industrial work tool known to persons skilled in the art. For purposes of this disclosure, in an exemplary embodiment, the end effector 120 depicted in FIG. 1 may embody a welding torch.

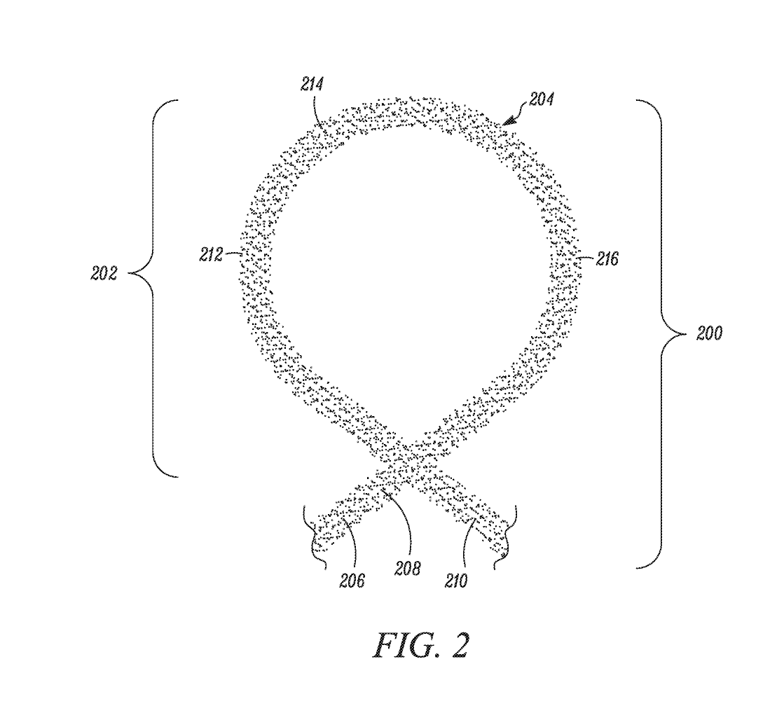

The present disclosure relates to the system 122 which is configured for facilitating a wireless operation of the end effector 120 and the robotic arm 106 of the robotic assembly 100. As shown in FIG. 1, the system 122 includes a remote control 124. The remote control 124 includes a sensor 126 that generates movement data 200 (shown pictorially in FIG. 2) corresponding to a movement of the remote control 124 by a user. Although, only one sensor 126 is depicted in the illustrated embodiment of FIG. 1, it may be noted that the number of sensors provided on the remote control 124 is merely exemplary in nature. Persons skilled in the art will acknowledge that any number of sensors may be provided in the remote control 124 depending on specific requirements of an application.

In an exemplary embodiment of this disclosure, the sensor 126 may embody an infra-red (IR) sensor that is capable of generating IR signals. The IR signals may be emitted from the IR sensor continuously or intermittently for example, at pre-determined time intervals of 500 milliseconds, 1 second, 2 seconds or any other time interval to meet specific requirements of an application. Although the sensor 126 is disclosed herein as an IR sensor, one skilled in the art will acknowledge that the IR sensor is non-limiting of this disclosure. Numerous other types of sensors including, but not limited to, ultrasonic sensors, microwave sensors, and the like are known in the art and such sensors may be readily implemented to form the sensor 126 of the present disclosure without deviating from the spirit of the present disclosure.

As shown in FIG. 2, the movement data 200 includes a plurality of spatially defined points 206, 208, 210 and so on. For purposes of this disclosure, the movement data 200 may be considered as a series of spatially defined points 206, 208, 210 and an on. Referring to FIG. 1, a primary switch 128 disposed on the remote control 124 is operable to commence a logging of the spatially defined points 206, 208, 210 present in the generated movement data 200 in a memory 134 of the system 122. In regards to the exemplary illustration of FIG. 2, the logged spatially defined points are collectively indicative of a circular path 204 and are individually designated by alpha-numerals 212, 214, 216, and so on.

As shown in FIG. 1, the system 122 also includes a receiver 130 disposed in wireless communication with the remote control 124. The receiver 130 receives the movement data 200 generated by the sensor 126. The receiver 130 may embody any type of motion detector including, but not limited to, an active/passive infrared motion detector, an ultrasound motion detector, a microwave doppler detector that is configured to trace a path consisting of the movement data 200 in which one or more spatially defined points 206, 208. 210 and so on may be logged, for example, the logged spatially defined points 212, 214, 216, and so on as shown in FIG. 2.

Referring to FIG. I, the system 122 also includes a processor 132 that is communicably coupled to the receiver 130. In response to the primary switch 128 being actuated on the remote control 124, the processor 132 logs the spatially defined points 212, 214, 216, and so on in the memory 134. The processor 132 disclosed herein may include a single microprocessor or multiple microprocessors. Numerous commercially available microprocessors can he configured to perform the functions of the processor 132. It should be appreciated that the processor 132 could readily be embodied in a general purpose microprocessor capable of controlling numerous robotic functions. As such, the processor 132 may also include additional memory devices, secondary storage devices, and any other components for running an application. Various circuits such as power supply circuitry, signal conditioning circuitry, solenoid driver circuitry and other types of circuitry may also be associated with the processor 132. Various routines, algorithms, and/or programs may be programmed within the processor 132 for execution thereof. Moreover, it should be noted that the processor 132 of the present disclosure may be a stand-alone processor or may be configured to co-operate with an existing processor/s (not shown) present on the robotic assembly 100 to perform functions consistent with the present disclosure.

The system 122 further includes a controller 136 that is communicably coupled to the processor 132, the memory 134, and at least one actuator 138 associated with the robotic assembly 100. One actuator 138 is shown associated with the robotic assembly 100 in the illustrated embodiment of FIG. 1. However, in other embodiments, a number of actuators used in the robotic assembly 100 may vary depending on a type and configuration of a robotic assembly used in a given application. The controller 136 is configured to command the actuator 138 for initiating movement of at least one of the robotic arm 106 and the end effector 120 based on the logged spatially defined points 212, 214, 216, and so on.

In one embodiment of this disclosure, the spatially defined points 212, 214, 216 are logged in the memory 134 in a first time period. In this embodiment, the controller 136 commands the actuator 138 to initiate movement of at least one of the robotic arm 106 and the end effector 120 in a second time period subsequent to the first time period. It is contemplated that in this embodiment upon logging the spatially defined points 212, 214, 216 by the processor 132 in the memory 134, the logged points 212, 214, 216 may be displayed on a graphical user interface (GUI) 140 (as shown in FIG. 1) for validation by the user prior to executing movement of the robotic arm 106 and the end effector 120 of the robotic assembly 100 in accordance with the logged spatially defined points 212, 214, 216. This way, the user can validate the paths of movement on the GUI 140 for the robotic arm 106 and the end effector 120 before-hand. Once the user approves or validates the path on the GUI 140, the controller 136 can command the actuator 138 to execute the individual movements of the robotic arm 106 and the end effector 120 respectively.

In an embodiment, the processor 132 is additionally configured to transform the logged spatially defined points 212, 214, 216 and time in an operational space (not shown) of the robotic assembly 100. The transformation of the logged spatially defined points 212, 214, 216 may be carried out in a Cartesian co-ordinate system, a Polar co-ordinate system, a cylindrical and spherical co-ordinate system, a homogenous co-ordinate system, a canonical co-ordinate system or any other co-ordinate system as known to persons skilled in the art.

In an alternative embodiment, the controller 136 can also be configured to command the actuator 138 to initiate movement of one or both of the robotic arm 106 and the end effector 120 in real time. Therefore, in this embodiment, movement of the robotic arm 106 and/or the end effector 120 as initiated by the controller 136 would be contemporaneous with movement of the remote control 124, contingent upon the primary switch 128 of the remote control 124 being actuated, to log the spatially defined points 212, 214, 216 in the movement data 200 generated by the sensor 126.

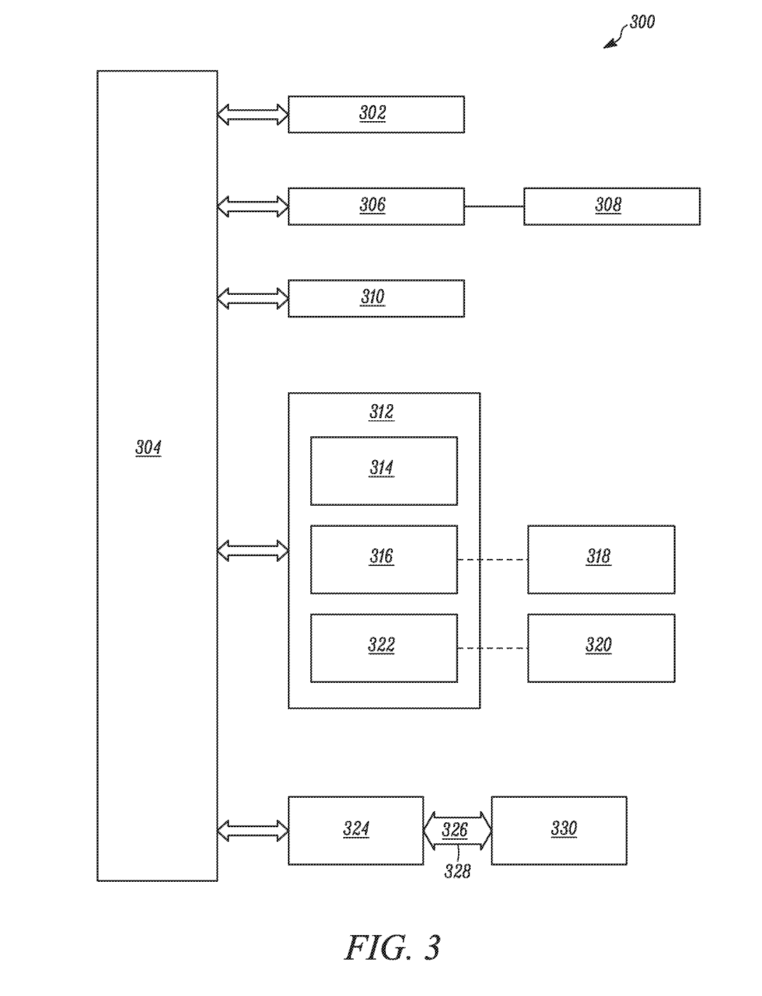

In various embodiments of this disclosure, it can be contemplated by persons skilled in the art to configure one or more components i.e., the processor 132, the memory 134, the controller 136, and the GUI 140 such that the processor 132, the memory 134, the controller 136, and/or the GUI 140 may form part of or reside in a computer-based system, for e.g., a computer-based system 300 shown in FIG. 3. Moreover, it can also be contemplated by persons skilled in the art to re-arrange, interchange, or modify the functions associated with one or more components of the system 122 disclosed herein. For example, it can be contemplated to omit the controller 136 altogether and instead configure the processor 132 to perform the functions associated with the controller 136 of this disclosure such that an operation of the actuator 138 may now be controlled by one or more commands provided by the processor 132 in lieu of the controller 136.

Additionally or optionally, in one embodiment, the remote control 124 may include a plurality of secondary switches 142 which are operable to wirelessly communicate with the receiver 130. In an embodiment, each of these secondary switches 142 is operable to provide at least one type of operational instruction to the end effector 120 of the robotic arm 106 for one or more spatially defined points 212, 214, 216 logged in the memory 134. The at least one type of operational instruction could include, but is not limited to, welding, cutting, painting, grinding, &buffing, material handling and assembly. Although some operations such as welding, cutting, painting, grinding, deburring, material handling and assembly are disclosed herein, it is to be noted that a type of operation is non-limiting of this disclosure. Any type of industrial operation may be incorporated for execution by the robotic assembly 100 depending on specific requirements of an application.

As disclosed earlier herein, with actuation of the primary switch 128, the spatially defined points 212, 214, 216 in the movement data 200 are logged by the processor 132 in the memory 134 and these logged points 212, 214, 216 form the basis on which the respective paths of movement for the robotic arm 106 and the end effector 120 are determined by the processor 132. Upon subsequent actuation of one of the secondary switches 142 present on the remote control 124, the processor 132 can provide a specific operational instruction to the end effector 120, for example, to perform a weld on a designated weld area on a component (not shown). It is contemplated that in one embodiment, the secondary switch 142 may be actuated upon actuation of the primary switch 128 to provide the specific operational instruction to the end effector 120 for execution at one or more of the logged spatially defined points 212, 214, 216.

Alternatively, in another embodiment, it can also be contemplated to configure the secondary switch 142 such that upon actuation of the secondary switch 142, the processor 132 logs the spatially defined points 212, 214, 216 in addition to providing the specific operational instruction, for example, welding to the end effector 120 via the receiver 130, the processor 132, and the controller 136. This way, the user could obviate the need to actuate the primary switch 128 for logging the spatially defined points 212, 214, 216 as the same command could now be issued in conjunction with the operational instruction when the secondary switch 142 is actuated. It will be appreciated that numerous other modifications may be contemplated by persons skilled in the art with regard to the functionality associated with the primary and secondary switches 128, 142 disclosed herein and it may be noted that such modifications do not limit the scope of the present disclosure, rather, such modifications are to be construed as falling within the scope of the appended claims.

In an additional embodiment of this disclosure, the remote control 124 may be releasably coupled with a 3-dimensional (3D) mold 144 of the end effector 120. The 3D mold 144 of the end effector 120 is configured to indicate to the user a type of end effector 120 being mounted on the robotic arm 106. In addition, it is also envisioned that by coupling the 3D mold 144 to the remote control 124, the user may experience an improved sense in locating a position of the end effector 120 on the robotic arm 106 while also improving a sense of dexterity in manually moving the remote control 124 and causing the sensor 126 to generate the movement data 200 therefrom.

FIG. 3 is an exemplary low-level implementation of a computer-based system 300 that can be configured to perform functions associated with the processor 132 of the system 122 from FIG. 1, in accordance with an embodiment of the present disclosure. It may be noted that the computer system 300 could be embodied as a programmable logic controller (PLC) or reside in any type of robotic architecture known to persons skilled in the art. Alternatively, the computer system 300 could be conveniently configured as a standalone entity in relation to the robotic assembly 100 for performing functions consistent with the present disclosure.

The present disclosure has been described herein in terms of functional block components and various processing steps. It should be appreciated that such functional blocks may be realized by any number of hardware and/or software components configured to perform the specified functions. For example, the system 122 may employ various integrated circuit components, e.g., memory elements, processing elements, logic elements, look-up tables, and/or the like, which may carry out a variety of functions under the control of one or more microprocessors or other control devices. Similarly, the software elements of the computer system 300 may be implemented with any programming or scripting language such as C. C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the computer system 300 may employ any number of conventional techniques for data transmission, signaling, data processing, network control, and/or the like. Still further, the computer system 300 could be configured to detect or prevent security issues with a user-side scripting language, such as JavaScript, VBScript or the like. In an embodiment of the present disclosure, the networking architecture between components of the computer system 300 may be implemented by way of a client-server architecture. In an additional embodiment of this disclosure, the client-server architecture may be built on a customizable.Net (dot-Net) platform. However, it may be apparent to a person ordinarily skilled in the art that various other software frameworks may be utilized to build the client-server architecture between components of the system 122 without departing from the spirit and scope of the disclosure.

These software elements may be loaded onto a general purpose computer, special purpose computer, or other programmable data processing apparatus to produce a machine, such that the instructions that execute on the computer or other programmable data processing apparatus create means for implementing the functions disclosed herein. These computer program instructions may also be stored in a computer-readable memory that can direct a computer or other programmable data processing apparatus to function in a particular manner, such that the instructions stored in the computer-readable memory produce instructions which implement the functions disclosed herein. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions disclosed herein.

The present disclosure (i.e., system 122,method 400, any part(s) or function(s) thereof) may be implemented using hardware, software or a combination thereof, and may be implemented in one or more computer systems or other processing systems. However, the manipulations performed by the present disclosure were often referred to in terms such as logging, validating, and the like, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers, specific-purpose digital computers or similar devices.

In accordance with an embodiment of the present disclosure, the present disclosure is directed towards one or more computer systems capable of carrying out the functionality described herein. An example of the computer based system includes a computer system 300, which is shown by way of a block diagram in FIG. 3.

The computer system 300 includes at least one processor, such as a processor 302. The processor 302 may be connected to a communication infrastructure 304, for example, a communications bus, a cross-over bar, a network, and the like. Various software embodiments are described in terms of this exemplary computer system 300. Upon perusal of the present description, it will become apparent to a person skilled in the relevant art(s) how to implement the present disclosure using other computer systems and/or architectures.

The computer system 300 includes a display interface 306 that forwards graphics, text, and other data from a communication infrastructure 304 for display on a display unit 308.

The computer system 300 further includes a main memory 310, such as random access memory (RAM), and may also include a secondary memory 312. The secondary memory 312 may further include, for example, a hard disk drive 314 and/or a removable storage drive 316, representing a floppy disk drive, a magnetic tape drive, an optical disk drive, etc. The removable storage drive 316 reads from and/or writes to a removable storage unit 318 in a well-known manner. The removable storage unit 318 may represent a floppy disk, magnetic tape or an optical disk, and may be read by and written to by a removable storage drive 316. As will be appreciated, the removable storage unit 318 includes a computer usable storage medium having stored therein, computer software and/or data.

In accordance with various embodiments of the present disclosure, the secondary memory 312 may include other similar devices for allowing computer programs or other instructions to be loaded into the computer system 300. Such devices may include, for example, a removable storage unit 320, and an interface 322. Examples of such may include a program cartridge and cartridge interface (such as that found in video game devices), a removable memory chip (such as an erasable programmable read only memory (EPROM), or programmable read only memory (PROM)) and associated socket, and other removable storage units 320 and one or more interfaces 322, which allow software and data to be transferred from the removable storage unit 320 to the computer system 300.

The computer system 300 may further include a communication interface 324. The communication interface 324 allows software and data to be transferred between the computer system 300 and one or more external devices 330. Examples of the communication interface 324 include, but may not be limited to a modem, a network interface (such as an Ethernet card), a communications port, a Personal Computer Memory Card International Association (PCMCIA) slot and card, and the like. Software and data transferred via the communication interface 324 may be in the form of a plurality of signals, hereinafter referred to as the signals 326, which may be electronic, electromagnetic, optical or other signals capable of being received by the communication interface 324. The signals 326 may be provided to the communication interface 324 via a communication path (e.g., channel) 328. The communication path 328 carries the signals 326 and such communication path 328 may be implemented using wire or cable, fiber optics, a telephone line, a cellular link, a radio frequency (RF) link and other communication channels.

In this document, the terms “computer program medium” and “computer usable medium” are used to generally refer to media such as a removable storage drive 316, a hard disk installed in a hard disk drive 314, the signals 326, and the like. These computer program products provide software to the computer system 300. The present disclosure is also directed to such computer program products.

One or more computer programs (also referred to as computer control logic) may be stored in the main memory 310 and/or the secondary memory 312. The computer programs may also be received via the communication interface 304. Such computer programs, when executed, enable the computer system 300 to perform the functions consistent with the present disclosure, as discussed herein. In particular, the computer programs, when executed, enable the processor 302 to perform the features of the present disclosure.

In accordance with an embodiment of the present disclosure, where the disclosure is implemented using a software, the software may be stored in a computer program product and loaded into the computer system 300 using the removable storage drive 316, the hard disk drive 314 or the communication interface 324. The control logic (software), when executed by the processor 302, causes the processor 302 to perform the functions of the present disclosure as described herein.

In another embodiment, the present disclosure is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present disclosure is implemented using a combination of both the hardware and the software.

Various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily inter that two elements are directly connected to each other.

Additionally, all numerical terms, such as, but not limited, to, “first”, “second”, “third”, “primary”, “secondary” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

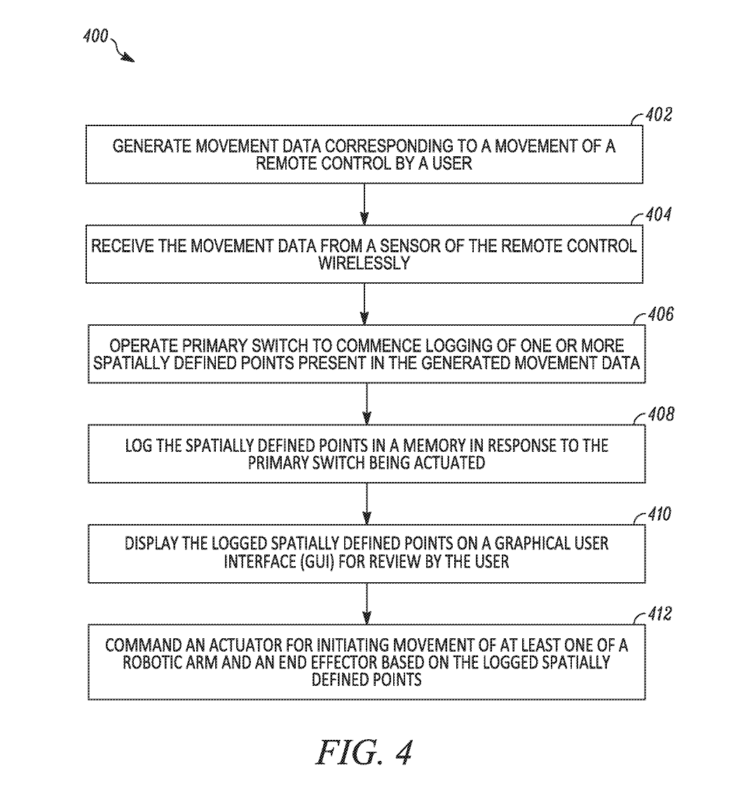

FIG. 4 illustrates a method 400 of operating the robotic arm 106 and the end effector 120 of the exemplary robotic assembly 100, in accordance with an embodiment of the present disclosure. Although the method 400 is explained in conjunction with the exemplary robotic assembly 100 of FIG. 1, it should be noted that the method 400 disclosed herein can be similarly applied on robotic assemblies of other configurations known to persons skilled in the art.

Referring to FIG. 4, at step 402, the method 400 includes generating movement data 200 corresponding to a movement of the remote control 124 by a user. At step 404, the method 400 further includes wirelessly receiving the movement data 200 from the sensor 126 of the remote control 124. At step 406, the method 400 further includes operating the primary switch 128 to commence logging of one or more spatially defined points 206, 208, 210 present in the generated movement data 200. At step 408, the method 400 further includes logging the spatially defined points 212, 214, 216 in the memory 134 in response to the primary switch 128 being actuated.

Additionally or optionally, in an embodiment as shown at step 410, the method 400 includes displaying the logged spatially defined points 212, 214, 216 by the processor 132 on the GUI 140 for review by the user. In this embodiment, the user can refine the logged spatially defined points 212, 214, 216 manually or by using an appropriate software in which changes can be made in the location of each spatially defined point 212, 214, 216.

Moreover, at step 412, the method 400 further includes commanding the actuator 138 for initiating movement of at least one of the robotic arm 106 and the end effector 120 based on the logged spatially defined points 212, 214, 216.

Embodiments of the present disclosure have applicability for use and implementation in facilitating control in the movements of a robotic arm and an end effector of a given robotic assembly. With implementation of the remote control disclosed herein, a user may require a simple movement or gesture of the remote control and an actuation of the primary switch to instruct a path of movement or command movement itself of the robotic arm and the end effector. Also, one or more operational instructions required to perform by the end effector such as, but not limited to, welding, cutting, painting, grinding, deburring, and material handling and assembly can be provided using the secondary switches.

Also, where variations are likely to be encountered in the size, geometry, and configuration of the parts or components to be worked on, a given robotic assembly can be easily and quickly configured using the system of the present disclosure to meet the positional requirements of the end effector so that the end effector can perform the required operations. Therefore, it is envisioned that the system of the present disclosure can impart flexibility to a user in manually controlling a given robotic assembly that would have otherwise offered a fixed automated solution. As manufacturers of components typically encounter different sizes, shapes, and configurations of components, the system of the present disclosure may help these manufacturers to benefit by way of reduced equipment and tooling costs as the differently sized and/or shaped components can be worked upon using a single robotic assembly.

While aspects of the present disclosure have been par shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A system for wirelessly operating an end effector and a robotic arm associated with a robotic assembly, the system comprising:
a remote control having:
at least one sensor configured to generate movement data corresponding to a movement of the remote control by a user;
a primary switch operable to commence logging of a plurality of spatially defined points present in the generated movement data;
a receiver disposed in wireless communication with the remote control, the receiver configured to receive the movement data generated by the sensor;
a processor communicably coupled to the receiver, the processor configured to log the plurality of spatially defined points in a memory in response to the primary switch being actuated; and
a controller communicably coupled to the processor, the memory, and at least one actuator associated with the robotic assembly, the controller configured to command the actuator for initiating movement of at least one of the robotic arm and the end effector based on the logged spatially defined points.

2. The system of claim 1, wherein the remote control further comprises a plurality of secondary switches operable to wirelessly communicate with the receiver each of the secondary switches being operable to provide at least one type of operational instruction to the end effector of the robotic arm for at least one spatially defined point logged in the memory.

3. The system of claim 2, wherein the at least one type of operational instruction consists of one of: welding, cutting, painting, grinding, deburring, material handling and assembly.

4. The system of claim 1 further comprising a 3-dimensional mold of the end effector releasably coupled to the remote control, the 3-dimensional mold of the end effector configured to indicate to the user a type of end effector being mounted on the robotic arm.

5. The system of claim 1, wherein the one or more spatially defined points is logged in the memory in a first time period.

6. The system of claim 5, wherein the controller is configured to command the actuator to initiate movement of at least one of the robotic arm and the end effector in a second time period subsequent to the first time period.

7. The system of claim 1, wherein the controller is configured to command the actuator to initiate movement of at least one of the robotic arm and the end effector in real time.

8. The system of claim 1, wherein the processor is configured to transform the logged spatially defined points and time in an operational space of the robotic assembly.

9. The system of claim 1 further comprising a graphical user interface (GUI) communicably coupled to the processor, wherein the graphical user interface (GUI) is configured to display the logged spatially defined points to a user.

10. The system of claim 1, wherein one or more of the processor, the memory, the controller, and the GUI reside on a computer based system.

11. A method of wirelessly operating an end effector and a robotic arm associated with a robotic assembly, the method comprising:
generating movement data, using at least one sensor, corresponding to a movement of a remote control by a user;
wirelessly receive the movement data generated by the sensor;
commence logging of a plurality of spatially defined points present in the generated movement data in response to an operation of a primary switch on the remote control;
log the plurality of spatially defined points in a memory by a processor in response to the primary switch being actuated.; and
command an actuator using a controller communicably coupled to the processor for initiating movement of at least one of the robotic arm and the end effector based on the logged spatially defined points.

12. The method of claim 11, wherein the logged spatially defined points are displayed on a graphical user interface (GUI) for review by a user.
